(19) United States
(12) Patent Application Publication
(10) Pub. No.: US 2022/0161083 A1
(43) Pub. Date: May 26, 2022

(54) FIRE PROTECTION DEVICE

(71) Applicant: Guardian Technologies GmbH, Wangen I.a. (DE)

(72) Inventors: Jack-Leonard Bolz-Mendel, Wangen i.A. (DE); Stanislav Malorodov, Wangen i.A. (DE)

(21) Appl. No.: 17/535,157

(22) Filed: Nov. 24, 2021

(30) Foreign Application Priority Data
Nov. 25, 2020 (EP) 20209943.8

(51) Int. Cl. A62C 37/40; A62C 31/28; A62C 31/02; A62C 3/02

(52) U.S. Cl. CPC A62C 37/40; A62C 3/0292; A62C 31/02; A62C 31/28

(57) ABSTRACT

Disclosed is a fire protection device (1) having at least one high-resolution detection unit (2, 3) which is configured to monitor a space for a fire event and to output a video data signal. The at least one high-resolution detection unit (2, 3) includes a wide-angle lens (4) with a detection angle equal to or greater than 100 degree to at least partially cover the space or a specific region of the same. Furthermore, the fire protection device has at least one movable extinguishing unit (100) configured to discharge an extinguishing agent to a location within the space in which a fire event is monitored by the at least one high-resolution detection unit (2, 3).

### CROSS REFERENCE TO RELATED APPLICATIONS

The benefit of priority to European Patent Application No. 20209943.8 filed Nov. 25, 2020, is hereby claimed and the disclosure is incorporated herein by reference in its entirety.

### FIELD OF THE INVENTION

The present invention relates to a fire protection device, in particular to an active fire protection system that enables automatic fire detection and suppression.

### BACKGROUND

Active fire protection devices are known in the prior art. Such fire protection devices typically comprise a fire detection device and a fire extinguishing or suppressing device for extinguishing a detected fire. However, current solutions that are used in buildings have the drawback that they are often bulky, space consuming and/or involve a high installation effort. Furthermore, known systems like sprinkler systems have the drawback that they are not able to locally extinguish or suppress fires. This often leads to damage caused by the extinguishing agent used. Furthermore, the activation of known systems is comparatively slow and does often not meet current needs and/or requirement. This may lead to undesired spreading of a fire which leads to a higher extinguishing effort.

### SUMMARY

In view of the above, it is the object of the invention to provide a fire protection device which at least addresses the above drawbacks.

The object is solved by a fire protection device according to claim 1. Advantageous further formations are subject of the dependent claims.

Disclosed is a fire protection device. The fire protection device may comprise a fire detection device. The fire detection device may comprise a flame detector and/or a heat detector and/or a smoke detector. The fire detection device, for example the flame detector, may comprise a high-resolution detection unit. The fire detection device may comprise a visual flame detector, for example at least one high-resolution detection unit. The high-resolution detection unit may be configured to detect information which allows to determine whether there is a fire and/or smoke. The high-resolution detection unit may comprise an imaging sensor. The high-resolution detection unit may be a camera system.

The fire detection device, for example comprising the high-resolution detection unit, can be configured to monitor a space for a fire event and to output a corresponding signal, for example a video data signal. According to the present disclosure, a space which is to be monitored by the high-resolution detection unit may be an interior space, in particular in a building, such as an office space, a commercial space or a private space. The space may also be an outdoor space such as a garden. While the latter mentioned spaces may be seen as spaces to which the present disclosure may be commonly applied it is noted that the use of the present disclosure is not limited to such applications. For example, it is also possible to use the disclosed fire protection device in agricultural appliances or agricultural technology for monitoring agricultural areas. Furthermore, compact sized fire protection devices of the kind described herein may also be used in non-stationary appliances such as on drones.

The high-resolution detection unit can be configured to monitor a predetermined region of the space. For that, the high-resolution detection unit may comprise a preset angle of view or field of view. The high-resolution detection unit may comprise a wide-angle lens. The wide-angle lens can comprise a detection angle equal to or greater than 100 degrees, for example both vertically and horizontally. The high-resolution detection unit may be configured to at least partially cover the space or a specific region of the same, for example a specific area of a floor with or without wall portions or ceiling portions. Accordingly, depending on a position at which the high-resolution detection unit is provided, the high-resolution detection unit will be able to monitor a predetermined region of the monitored space. For example, the high-resolution detection unit can be provided such that at least during monitoring, the high-resolution detection unit is oriented substantially perpendicular to a wall or ceiling surface of the space. In such a configuration, the high-resolution detection unit may comprise a wide-angle lens having a detection angle which is greater than 130 degrees. For example, it is possible to use a wide-angle lens having a detection angle of 180 degrees. In this way, it is possible to monitor a large region of the space or substantially the entire space. In an exemplary configuration, the high-resolution detection unit may also be provided at an angle with respect to a wall or ceiling surface of the space to be monitored. In such a configuration, the angle of the wide-angle lens may be chosen depending on an angle spanned between the main orientation direction of the high-resolution detection unit and an adjacent wall or ceiling surface to which it is mounted. For example, if the high-resolution detection unit is mounted in a corner of the space, the angles spanned between the main orientation direction of the high-resolution detection unit, two adjacent wall surfaces and the ceiling surface may be taken into account for correctly determining the angle of the wide-angle lens to be used.

The fire protection device may further comprise at least one movable extinguishing unit configured to discharge an extinguishing agent to a location within the space in which a fire event is monitored by the at least one high-resolution detection unit. Accordingly, the extinguishing unit is on the one hand able to output an extinguishing agent and is on the other hand movable so as to correctly orient the movable extinguishing unit towards the detected fire event. According to the present disclosure, the term fire event may relate to an event in which a temperature higher than a predetermined temperature is detected and/or flames are detected.

According to the present disclosure, the fire protection device may be configured to determine a location in which a fire event is detected. For that, the fire protection device can be configured to determine three dimensional coordinates indicating the location of the fire event. The fire protection device can be configured to determine coordinates based on the video data signal output from the high-resolution detection unit. Based on the detected location, the fire protection device may be configured to move the movable extinguishing unit such that an output device thereof, for example a nozzle, is oriented such that an extinguishing agent reaches the location in which a fire event is detected.

According to an exemplary embodiment of the present disclosure, the at least one high-resolution detection unit may comprise an image sensor. The high-resolution detection unit, for example the image sensor, may comprise a resolution which is equal to or more than one megapixel. In an exemplary embodiment, the high-resolution detection unit comprises a resolution of equal to or more than six megapixels.

According to an exemplary embodiment of the present disclosure, the at least one high-resolution detection unit may include an infrared prefilter. The infrared prefilter may be formed as a high pass filter. The infrared prefilter may comprise a near infrared filter. In an exemplary embodiment, the infrared prefilter is configured to allow light having a wavelength equal to or greater than 950 nm to pass therethrough. Accordingly, it is possible to filter undesired wavelengths that do not contribute to detecting a fire event.

According to an exemplary embodiment, the fire protection device may comprise a control unit. The control unit may be configured to control a movement of the movable extinguishing unit based on the video data signal received from the at least one high-resolution detection unit. The control unit may be configured to identify a fire event in the video data signal based on machine learning and/or to determine coordinates from the video data signal, preferably three-dimensional coordinates, to determine the location in which the fire event is identified. The identification of a fire event may be carried out based on machine learning, for example through use of a trained neural network.

According to an exemplary embodiment of the present disclosure, the fire protection device may comprise a movable extinguishing unit which is at least movable between a standby position and an operating position. The standby position may be a position in which the extinguishing unit is in a stowed state. In the stowed state, the extinguishing unit may be accommodated in a housing. In the standby position, the extinguishing unit may be in a state in which it is not able to fight a fire. In particular, in such a standby position, the extinguishing unit may be accommodated or at least oriented such that it is not possible to output an extinguishing agent towards the location of the detected fire event. The operating position may be at least a position in which the extinguishing device is able to fight a fire. In other words, in the operating position, it is possible to output an extinguishing agent towards the location at which a fire event was detected. The standby position may in addition or alternatively be a position in which the movable extinguishing unit is oriented towards a predetermined location in the monitored space. Such a predetermined location may be for example the center of the monitored space or the center of the floor area of the monitored space. In this way, the reaction time of the fire protection device may be enhanced as an orientation of the movable extinguishing unit towards the location of a detected fire event may be accelerated.

According to an exemplary embodiment of the present disclosure, the fire protection device may be a stationary fire protection device. In the context of the present disclosure, stationary fire protection device is to be understood as a device in which the mounting position of the device remains stationary in the space to be monitored. In other words, the stationary fire protection device may be fixedly mounted in the space to be monitored. For example, the high-resolution detection unit can be arranged and/or provided such that it is fixedly and non-movably arranged at a specific position within the space to be monitored. The high-resolution detection unit can be fixedly and non-movably provided on a wall or ceiling of the space to be monitored. In such a configuration, the detection region in the space to be monitored cannot be changed. In particular, in such a configuration, the high-resolution detection unit is not moved for scanning a specific area in the space to be monitored, remains stationary and can only monitor the region or area within its field of view.

According to an embodiment of the present disclosure, the movable extinguishing unit may be supported at least partially translatory and/or at least partially rotatably movable along a path by means of a supporting assembly or support arrangement, for example comprising a bearing. The supporting assembly may be configured to support the movable extinguishing unit so as to be movable along a straight path. In addition or alternatively, the movable extinguishing unit may be rotatably held by means of a pivot bearing arrangement. The pivot bearing arrangement may comprise two pivot bearings supporting the movable extinguishing unit rotatable about two rotational axis that may for example be oriented perpendicular to each other. One of the two pivot bearings may be configured such that a main extension direction of its first rotational axis is parallel to a main extension direction of the path described before.

Accordingly, a configuration may be provided in which the movable extinguishing unit is moved along a substantially straight path for moving the same from the standby position to the operating position. With such a movement, it is for example possible to move the movable extinguishing unit out of a housing or an accommodating portion provided within the wall or ceiling of the space. In a preferable configuration, an orientation movement of the movable extinguishing unit by means of the pivot bearing arrangement may already be at least partially carried out during transfer of the movable extinguishing unit from the standby position to the operating position. In this way, the time which is necessary for orienting the movable extinguishing unit towards the location of the detected fire event may be reduced.

According to an embodiment of the present disclosure, at least one high-resolution detection unit is provided on the movable extinguishing unit. Accordingly, at least one high-resolution detection unit can be provided on the movable extinguishing unit so as to be integrally movable with the same. The movable extinguishing unit may be configured so as to orient and hold the high-resolution detection unit towards at least a predetermined region of the space to be monitored. During monitoring, the movable extinguishing unit is held immovably so that the high-resolution detection device may monitor a predetermined area. In addition or alternatively, the movable extinguishing unit can be configured such that the high-resolution detection unit is oriented perpendicular with respect to a wall or ceiling surface on which the fire protection device is mounted. In addition or alternatively, the main orientation direction of the high-resolution detection unit may be parallel to the first rotational axis of the pivot bearing arrangement and/or parallel to the main extension direction of the path along which the movable extinguishing unit is moved from the standby position to the operating position.

According to an embodiment of the present disclosure, the movable extinguishing unit may comprise a housing with a cover portion. The cover portion may be a flat cover portion. The cover portion may be configured such that in the stowed state of the movable extinguishing unit, the cover portion substantially seamlessly integrates in a surrounding surface structure, for example a housing surface of the fire protection device or a wall or ceiling surface, wherein the high-resolution detection unit can be provided in or on the cover portion. The cover portion may comprise an opening for the high-resolution detection unit. In addition or alternatively, at least one high-resolution detection unit may be provided remote and independent from the movable extinguishing unit so as to remain independent of a movement of the movable extinguishing unit. In addition or alternatively, at least a portion of the cover portion comprises an indicating portion configured to signalize a detected fire event and/or activity and/or movement of the movable extinguishing unit. For example, the indicating portion can be configured to provide a visual signal and may comprise a translucent section allowing light of an interior signal light to pass therethrough. The translucent section may comprise diffuse characteristics and may be made from a plastics material.

According to a further exemplary embodiment of the present disclosure the movable extinguishing unit may comprise an extinguishing nozzle for applying an extinguishing agent. An output opening of the extinguishing nozzle may comprise a diameter equal to or smaller than 10 mm. According to a further configuration, the output opening of the extinguishing nozzle may comprise a diameter which is equal to or smaller than 1 mm. A very specific but nonlimiting a configuration may comprise a nozzle with a diameter of 0.8 millimeters. According to an exemplary configuration, the extinguishing nozzle may be a nozzle which is normally used in 3D printers for printing purposes. Accordingly, it is possible to use an already available nozzle for fire extinguishing purposes.

According to a further exemplary embodiment of the present disclosure, the movable extinguishing unit may comprise a thermal radiation detection device. The thermal radiation detection device may be at least used to verify a fire event detected by the high-resolution detection unit. The extinguishing nozzle and the thermal radiation detection device may be oriented in parallel. In other words, the extinguishing nozzle and the thermal radiation detection device may be oriented in the same direction. In such a configuration, the extinguishing nozzle may always be oriented in the direction of the thermal radiation detection device so that there is no or almost no need to additionally and/or separately orient the extinguishing nozzle after verification of the fire event based on data received from the thermal radiation detection device.

The fire protection device may further comprise a distance sensor for determining a distance between a detected fire event and the movable extinguishing unit. The distance sensor may be arranged on the movable extinguishing unit, for example with an orientation that is parallel to the orientation of the extinguishing nozzle and/or parallel to an orientation of a thermal radiation detection device. The distance sensor, the extinguishing nozzle and/or the thermal radiation detection device may be arranged on the same side of the movable extinguishing unit. It is also possible to provide the distance sensor and/or the extinguishing nozzle and/or the thermal radiation detection device on opposite sides of the movable extinguishing unit. In other words, the latter components may be arranged such that they face away from each other. For example, the extinguishing nozzle and the thermal radiation unit may face in one direction and the distance sensor may face in opposite direction. The housing of the movable extinguishing unit may comprise corresponding openings for the latter components.

According to an embodiment of the present disclosure, the fire protection device may comprise a pump device and an extinguishing agent reservoir. The pump device is connected to the extinguishing agent reservoir and configured to supply an extinguishing agent from the reservoir to at least one movable extinguishing unit, in particular to a nozzle thereof. The pump device may comprise a pump with a flow rate of 5 liters per minute or less. For example, the pump may comprise a flow rate of 3 liters per minute or less. In an exemplary embodiment, the pump may comprise a flow rate of 1 liter per minute or less. A specific exemplary embodiment may comprise a pump with a flow rate of 0.5 to 0.6 liters. In addition or alternatively, an operating pressure of the pump may be in a range from 10 bar to 30 bar and may in a specific but nonlimiting embodiment be in a range from 10 bar to 20 bar. In addition or alternatively, the extinguishing agent reservoir may comprise a volume which is equal to or smaller than 5 liters. In an exemplary configuration, the extinguishing agent reservoir may in addition or alternatively be configured as a replaceable cartridge. In another exemplary configuration, the extinguishing agent reservoir is configured refillable and, for that purpose, may comprise a refill valve. The extinguishing agent reservoir, the pump device and the nozzle may be dimensioned and adjusted such that a continuous output of extinguishing agent is possible for 5 min to 15 min.

According to a further exemplary embodiment of the present disclosure, the fire protection device comprises a housing which is configured to be installed in or on a wall and/or in or on a ceiling and/or in or on a furniture of the space to be monitored. The housing may be configured to fully accommodate the movable extinguishing unit, the reservoir and/or the control unit in the housing when the movable extinguishing unit is in the standby position. In addition or alternatively, the housing may comprise an opening through which the movable extinguishing unit may be at least partially passed to move the same to the operating position. The housing may comprise a compact size equal to or smaller than 1000 mm×1000 mm×1000 mm. In addition or alternatively, the housing may be configured couplable to a wall or ceiling by means of an engaging mount. The engaging mount may comprise a bayonet mount or a hook mount. The housing may be openable and closable for granting access to an interior of the same. For that, the housing may comprise a flap or door arrangement.

The fire protection device may be configured to be coupled to a household power supply. The fire protection device may comprise an ethernet interface and power may be supplied over ethernet. Furthermore, the fire protection device may comprise a backup power supply, in particular an accumulator so that an operation of the fire protection device remains available even in case the power is cut off.

It is noted that the features of the above and below mentioned embodiments may be suitably combined. Although a high-resolution detection unit is described, any fire detection device may be used instead. For example, a smoke detecting device may be provided.

Additional features and advantages of the above aspects and embodiments may be gleaned by the person skilled in the art from the following description of exemplary embodiments, which are not to be construed as limiting, however, drawing reference to the attached drawings.

### BRIEF DESCRIPTION OF THE DRAWINGS

The accompanying drawings, which are incorporated herein and form part of the specification, illustrate embodiments and, together with the description, further serve to explain the principles of the embodiments and to enable a person skilled in the art to make and use the embodiments.

FIG. 1 shows a side view of an embodiment of a fire protection device according to the present disclosure.

FIG. 2 shows a bottom view of the embodiment shown in FIG. 1.

FIG. 3 shows a top view of the embodiment shown in FIG. 1.

FIG. 4 shows a side view of the embodiment of FIG. 1.

FIG. 5 shows a bottom view of a movable extinguishing unit according to the embodiment of FIG. 1.

FIG. 6 shows a perspective view of main components of the embodiment shown in FIG. 1.

The features and advantages of the embodiments will become more apparent from the detailed description as given below when taken in conjunction with the drawings, in which like reference signs identify corresponding elements throughout. In the drawings like reference numbers generally indicate identical, functionally similar and/or structurally similar elements.

### DETAILED DESCRIPTION OF EMBODIMENTS

Embodiments and modifications will be described in the following with reference to the drawings. The following detailed description is merely exemplary in nature and is not intended to limit application and uses. Furthermore, there is no intention to be bound by any theory presented in the preceding background or summary or the following detailed description.

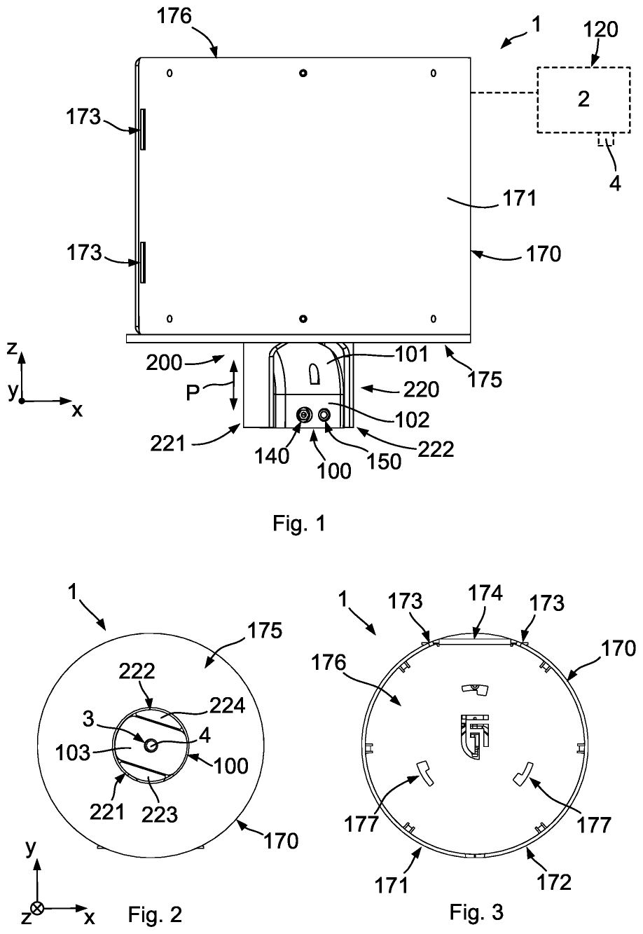

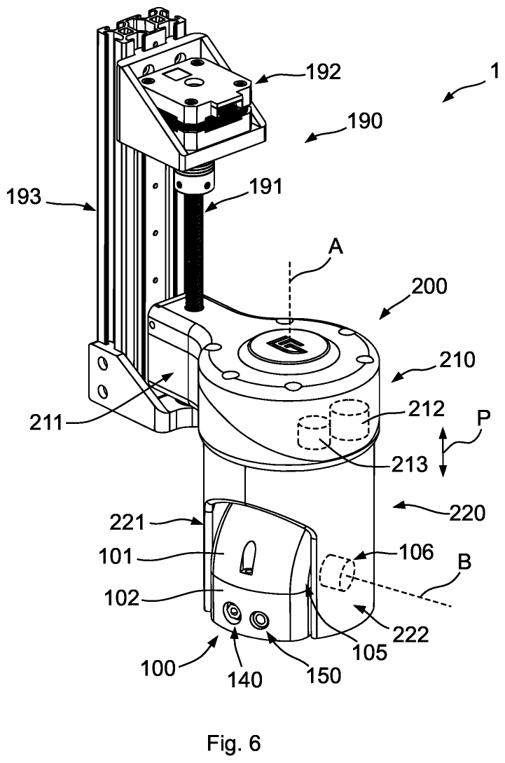

FIGS. 1 to 6 show details of a fire protection device 1 according to an embodiment of the present disclosure. The fire protection device 1 according to the embodiment comprises a movable extinguishing unit 100, an optional housing 170 and at least one fire detection device 120, which for example comprises a high-resolution detection unit 2, 3 comprising a wide-angle lens 4. The high-resolution detection unit 2, 3 is configured to monitor a predetermined area of a space, for example a closed space in a residential or commercial building. However, different configurations including configurations in which an outdoor space is monitored are also possible.

The movable extinguishing unit 100 comprises an extinguishing nozzle 140 and a thermal radiation detection device 150 accommodated in a housing which is formed by an upper housing portion 101 and a lower housing portion 102. A high-resolution detection unit 3 with a wide-angle lens 4 is provided in a bottom portion 103 of the lower housing portion 102 as is shown in FIG. 2. Although two high-resolution detection units 2, 3 are shown in the embodiment, it is noted that a single fire detection device 120, for example a single high-resolution detection unit 3 provided on the movable extinguishing unit 100, may be used. At least one fire detection device 120 may be provided remote and independent from movable extinguishing unit, for example on a wall or ceiling of a monitored space.

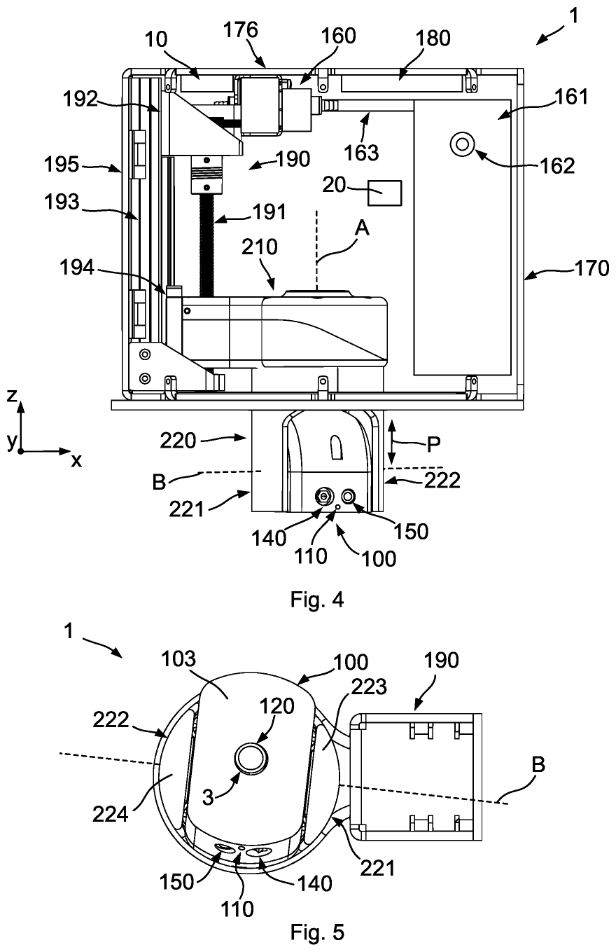

As shown in FIGS. 4 and 5, a distance sensor 110 for determining a distance between the detected fire event and the movable extinguishing unit 100 may be provided. The distance sensor 110 may be arranged on the movable extinguishing unit 100 with an orientation that is parallel to the orientation of the extinguishing nozzle 140 and/or parallel to an orientation of a thermal radiation detection device 150. The distance sensor 110 may be coupled to the control unit 10. Based on the information received from the distance sensor 110, the position of the fire event may be determined with even higher accuracy. An exact location allows for a more precise generation of an extinguishing agent output by correspondingly controlling the pump and/or orientation of the nozzle 140.

The movable extinguishing unit 100 is rotatably supported on a support arrangement 200 which will be described with reference to FIGS. 1, 4, 5 and 6. The support arrangement 200 comprises an accommodating portion 220 which is configured to receive and support the movable extinguishing unit 100 rotatably about an axis B. Furthermore, the support arrangement comprises a support portion 210 which is configured to rotatably hold the accommodating portion 220 and to be coupled to a drive mechanism 190 for moving the support arrangement and, thus, the movable extinguishing unit 100.

The accommodating portion 220 of the support arrangement 200 may comprise a fork like structure with two prongs that are configured to hold the movable extinguishing unit 100 between them. More precisely, according to the embodiment, the support arrangement 200 comprises a first leg portion 221 and a second leg portion 222 extending substantially parallel with respect to each other and configured to support the movable extinguishing unit 100 on opposite sides. Lower end surfaces 223, 224 of the first and second leg portions 221, 222 may be formed flat and in the same plane. The bottom portion 103 of the movable extinguishing unit 100 may also be formed flat and the movable extinguishing unit 100 may be arranged such that the bottom portion 103 or its outer surface may be aligned with the lower end surfaces 223, 224 of the first and second leg portions 221, 222 when the movable extinguishing device 100 is in a standby position. The lower end surfaces 223, 224 and the bottom portion 103 may together form a substantially circular surface. Furthermore, the housing of the movable extinguishing unit 100 and the first and second leg portions 221, 222 may be formed such that they together form a substantially cylindrical body.

The support arrangement 200 is configured such that the accommodating portion 220 is rotatable about an axis A which is substantially perpendicular to the rotation axis B about which the movable extinguishing unit 100 is rotatably held on the accommodating portion 220. The support portion 210 supports the accommodating portion 220 rotatably about axis A. The support portion 210 is held on the drive mechanism in a cantilevered manner. The support portion 210 comprises a housing 211 which is coupled to the drive mechanism 190 at one portion and supports the accommodating portion 220 at another portion. A drive motor 212 is operatively coupled to the accommodating portion 220 by means of a transmission 213 for actively moving the accommodating portion 220 about axis A.

The support arrangement 200 may, by means of the drive mechanism 190, be movable along a straight path P which in the shown configuration corresponds to an up and down direction. In general, the support arrangement 200 may be configured so as to be able to retract the movable extinguishing unit 100 into the housing 170 in order to transfer the same into a stowed state or standby position. By moving the movable extinguishing unit 100 in opposite direction, the same may be deployed for firefighting, more precisely brought to the operating position. In other words, the support arrangement 200 may be used to transfer the movable extinguishing unit 100 from the standby position to an operating position and vice versa. In FIG. 1, an operating position of the movable extinguishing unit 100 is shown. The fire protection device 1 as shown in FIG. 1 is thus in an operating state. As is shown in FIG. 4, axis A and straight path P extend in parallel to each other whereas axis B about which the movable extinguishing unit 100 is rotatable with respect to the support arrangement is perpendicular to axis A in the embodiment. Other extension directions of the axes are possible as long as the movable extinguishing unit 100 can be oriented towards a detected fire event. In case the path P is curved, axis A may extend in parallel with a main extension direction of path P, for example defined by a line connecting a start point of the path and an end point of the path.

The drive mechanism 190 is embodied as a linear drive mechanism. The drive mechanism may comprise a spindle drive 191 with a drive motor 192. The spindle drive 191 may be operatively coupled to the support arrangement 200, for example by coupling the spindle to the support portion 210. The drive mechanism 190 may further comprise a guide 193 embodied as a straight rail, and a support member 194 embodied as a carriage. The support member 194 is translatory movable on the guide 193. The support arrangement 200, more precisely the support portion 210, may be fixedly coupled to the support member 194 and integrally movable therewith. Accordingly, by driving the spindle drive 191, the support arrangement 200 may be translatory moved along the guide 193 in the direction of path P. The drive mechanism 190 may further comprise a base support member 195 on which the guide 193, the spindle drive 191 and the support member 194 are mounted. The base support member 195 is configured to mount the drive mechanism, the support arrangement 200 and the movable extinguishing unit 100 to a further system component, such as the housing 170. Alternatively, the base support member 195 may be an integral part of housing 170 and may be a portion of a wall portion of the housing 170.

Some members of the movable extinguishing unit 100 were already described before. The movable extinguishing unit 100 may comprise a pivot arrangement for rotatably coupling the same to the support arrangement 200. The pivot arrangement may comprise a coupling member 106, for example a pin, which may be rotatably supported on a support structure 105 and may be coupled to the support arrangement 200. The pin may be coupled to a drive device, for example a step motor, which is configured to rotate the coupling member 106. The coupling member 106 may be fixedly coupled to the support arrangement so that the movable extinguishing unit 100 rotates about the coupling member 106 when the drive device is driven.

he housing 170 is configured as a cylindrical housing although other configurations like a box shape may also be provided. The housing comprises a bottom portion 175 a top portion 176 and doors 171, 172 that are hingedly coupled to a main support structure 174 by means of hinges 173. The doors 171, 172 are provided to grant access to an interior of the housing 170 where main components of the fire protection device 1 are provided. In the top portion 176 of the housing 170, engaging recesses 177 are provided to allow for a bayonet like fixation of the fire protection device 1 on a suitable support base such as a mounting plate mountable on a wall or ceiling prior to mounting the fire protection device 1. A portion of the bottom portion 175 is configured translucent and is made of a material having diffuse characteristics. A signal light may be provided in the housing and light generated by the same may be transmitted through the bottom portion 175 so as to be visible from outside. In this way, a detected fire event (alarm) and/or operation of the fire protection device 1 may be visually indicated, for example lighting the bottom portion 175 with a specific color.

As is shown in FIG. 4, the fire protection device 1 may comprise, an extinguishing agent reservoir 161, a pump device 160, an optional back-up energy source 180, for example an accumulator, and a control unit 10 which is able to process data received form the fire detection device, for example a video data signal received from the high-resolution detection unit 2 or the high-resolution detection unit 3. The control unit 10 is coupled to a power supply 20, for example comprising a connector for coupling to a household power supply. The connector may be configured to receive power over ethernet and may comprise an ethernet connector for an attachment of an ethernet cable. Furthermore, the control unit 10 is coupled to the pump device 160, the fire detection device 2, 3, the drive mechanism 190, the support arrangement 200 and the movable extinguishing unit 100 for controlling the same based on the signal received from the fire detection device(s) and the thermal radiation detection unit 150. The pump device 160 is coupled to the extinguishing agent reservoir 161 by means of a pipe or hose 163. The extinguishing agent reservoir 161 may comprise a refill valve 162. Furthermore, the extinguishing agent reservoir 161 may be configured replaceable so that an empty reservoir may be replaced by a filled reservoir. Furthermore, the pump device 160 is connected to the nozzle 140 by a suitable piping or hose.

In the following, the function of the fire protection device 1 will be exemplary described. The fire protection device 1 is normally in standby mode in which the movable extinguishing unit 100 is in a retracted position and in which the same may be accommodated in the housing 170. FIG. 2 shows such a state. The movable extinguishing unit is retracted in the housing 170 with the bottom surface 103 being aligned with an outer surface of the bottom portion 175 of the housing. In this state, the fire detection unit continuously monitors the space, for example a high-resolution detection unit 3 continuously delivers video data signals to the control unit 10. Accordingly, the space to be monitored is permanently or continuously monitored for a fire event by the high-resolution detection unit 3 during standby mode. The high-resolution detection unit 3, for example an image sensor comprising an infrared prefilter, continuously delivers the video data signals to the control unit. The control unit 10 determines whether there is a high probability of a fire or smoldering. This can be done by detecting fire and/or smoke. In case a fire event is determined, the control unit calculates three dimensional coordinates of the position of the fire event and activates the movable extinguishing unit 100. In case of a detected fire event, the control unit 10 activates the movable extinguishing unit 100 and supplies the same with the coordinates. The movable extinguishing unit 100 is then moved from the standby position to an operating position through operation of the drive mechanism 190 controlled by the control unit 10. The movable extinguishing unit 100 is then oriented towards the coordinates of the detected fire event in such a manner that the thermal radiation detection device 150 is oriented towards the detected position. Based on a signal received from the thermal radiation detection device 150, the control unit verifies the presence of a fire and confirms the detected fire event. The control unit then activates an output of the extinguishing agent by controlling the pump 160 and the orientation of the nozzle 140. According to the embodiment, the high-resolution detection unit 3 may be deactivated as soon as a fire event is detected, and the coordinates are determined. In other words, monitoring by the high-resolution detection unit 3 may be interrupted if a fire event is detected based on the signal detected by the same.

Accordingly, a locally mounted extinguishing system is provided which may be mounted as a complete unit including mechanical components, control, processing, extinguishing agent reservoir, housing and any other parts necessary for operating the system. Embodiments of the disclosed do not need any connection to an external extinguishing agent supply. The system only requires a standard household power supply. For example, the fire protection device may be powered by power over ethernet. In case of a power failure, it may be supplied by a backup battery and operates autonomously. The place of installation can be chosen freely, preferably on the ceiling. In case of suspended ceilings/grid ceilings, installation above such ceilings is also possible. In the latter case, only a service opening is visible through which the fire detection device, for example the high-resolution detection unit 3, can monitor the room. The sensor has a wide angle in order to view as large areas as possible. The system can extend and retract a movable extinguishing unit 100 comprising an extinguishing nozzle 140 in one direction P, rotate around an axis A parallel thereto and swivel the nozzle about axis B which may be perpendicular to axis A. In this way, it is possible to orient the nozzle to any point in the room.

In the standby state of the system, the movable extinguishing unit 100 is retracted and barely visible from outside. The imaging sensor that “monitors” the room may positioned directly next to the housing 170 with a view in the direction of the direction P. Alternatively or in addition, the imaging sensor may be provided on the movable extinguishing unit 100.

In an embodiment, the fire detection device may comprise a processing hardware (control unit), an imaging sensor (camera, for example an RGB camera or monochrome camera), an infrared filter, an optional smoke detection module, a thermal radiation detection device. The thermal radiation detection device may be configured to deliver thermal image data and may comprise a pyrometer, a thermal sensor, an infrared sensor or a thermal camera. The thermal radiation detection device may be configured to have a higher sensitivity compared to the imaging sensor used for example in a camera. Accordingly, the imaging sensor or camera using the same may be used for monitoring a space and determining whether a fire event is present whereas the thermal radiation detection device may be used to verify the detected event with even higher accuracy and to allow a more detailed determination of the position of the fire event. In general, a configuration is possible in which a large area monitoring or detection provided by the fire detection device, in particular by an imaging sensor such as the above-described high-resolution detection unit in combination with a wide-angle lens, is combined with a smaller area detection of higher accuracy, for example provided by the thermal radiation detection device. Furthermore, the fire detection device may comprise an optical and/or acoustic signaling unit (lighting of the bottom portion 175 of the housing and/or a loudspeaker). The imaging sensor may be equipped with a wide-angle lens with a field of view or view angle in a range from 1 degree to 180 degrees.

The imaging sensor may record data and may transmit them to the local processing control (control unit). In the control unit, the image is processed based on machine learning algorithms, for example by a neural network, on the basis of various criteria, whether in the individual frame (image section) an event (fire, smoke, etc.) is present. If no, the process is repeated. If yes, the system status changes to “Event”. The software calculates the relative position of the event in the monitored space to the position of the sensor (in polar coordinates). Additionally a corresponding notification of stored telephone numbers, possibly the fire department, fire alarm center, push notifications of any type, a voice alarm, an artificial intelligence based call, and/or the visual and acoustic alarm may be initiated.

If an event is detected, the system moves the extinguishing unit 100 along path P to the operating position, so that the nozzle may be oriented towards any coordinate. At the nozzle there is a thermal radiation detection device, for example an infrared sensor oriented in axial direction of the nozzle. When the nozzle has reached a target position, the infrared sensor may check whether the detected event of the fire detection is actually a fire by determining the temperature. If this comparison is verified, the system starts the extinguishing process. If not, the system will return to the standby state.

In the extinguishing process, the extinguishing agent is pumped from the reservoir and supplied through the nozzle towards the determined coordinates. At the start of extinguishing, the system may precisely target the determined fire center based on the generated data, and an artificial intelligence may take over the coordination of the further deletion, for example to extinguish fires according to their size (from large to small in case of several fires). The system may continuously check whether the fire is still active or not. As soon as the system confirms that the fire has been extinguished, the system returns to its standby position and state.

Accordingly, the fire protection device may comprise one of the following features and characteristics. The fire protection device can be installed locally and does not require any external extinguishing agent supply, such as a water supply. The system may be operated with a standard household power supply so that no special power supply is necessary. As already mentioned, the system may be configured to be supplied with power by power over ethernet. A backup battery may be provided as a safeguard in case of power failure. The movable extinguishing unit may be retractable and extendable. An extinguishing agent reservoir may be directly arranged in the fire protection system so that no extra space is required. Extinguishing agent may be precisely directed into the center of a fire. The fire protection device may store detected events in order to use them for the analysis of the fire. In case of fire, the fire protection device may also provide a visual and acoustic alarm to make people aware of it. The optical alarm may be triggered by light signals, acoustic alarms by signals (beeps) or even by voice alarms or the playback of stored voice sequences. The number of imaging sensors and filters used may be adapted to the space to be monitored. In case of a detected event, the system may drive the movable extinguishing unit, so that the extinguishing nozzle is freely orientable in the room. Drive devices of the fire protection device may position the extinguishing nozzle on the basis of the data transmitted by the fire detection device. The event may additionally be verified by a thermal radiation detection unit. The thermal radiation detection unit may serve for determining the exact location of a fire. After successful validation by the thermal radiation detection unit which may be attached next to the nozzle, the control unit may identify the hottest point and may calculate the most effective trajectory for extinguishing the fire as quickly as possible with as little extinguishing agent as possible. The fire protection device 1 as described herein may not only be configured to be mounted to a wall or ceiling but may also be configured to be mounted on or in furniture.

In conclusion a, it is pointed out that the terms like “comprising” or the like are not intended to rule out the provision of additional elements or steps. Let it further be noted that “a” or “an” do not preclude a plurality. In addition, features described in conjunction with the different embodiments can be combined with each other however desired. It is also noted that the reference numbers in the claims are not to be construed as limiting the scope of the claims. Moreover, while at least one exemplary embodiment has been presented in the foregoing summary and detailed description, it should be appreciated that a vast number of variations exist.

It should also be appreciated that the exemplary embodiment or exemplary embodiments are only examples, and are not intended to limit the scope, applicability, or configuration in any way. Rather, the foregoing summary and detailed description will provide those skilled in the art with a convenient roadmap for implementing an exemplary embodiment, it being understood that various changes may be made in the function and arrangement of elements described in an exemplary embodiment without departing from the scope as set forth in the appended claims and their legal equivalents.

1. A fire protection device (1) comprising at least one high-resolution detection unit (2, 3) which is configured to monitor a space for a fire event and to output a video data signal, wherein said at least one high-resolution detection unit (2, 3) includes a wide angle lens (4) with a detection angle equal to or greater than 100 degree to at least partially cover said space or a specific region of the same, and at least one movable extinguishing unit (100) configured to discharge an extinguishing agent to a location within said space in which a fire event is monitored by said at least one high-resolution detection unit (2, 3).

2. The fire protection device (1) according to claim 1, wherein said at least one high-resolution detection unit (2, 3) comprises an image sensor, wherein said at least one high-resolution detection unit (2, 3) comprises a resolution of equal to or more than 1 megapixel.

3. The fire protection device according to claim 1, wherein said at least one high-resolution detection unit (2, 3) includes an infrared prefilter, wherein said infrared prefilter is formed as a high pass filter allowing light having a wavelength equal to or greater than 950 nm to pass therethrough.

4. The fire protection device (1) according to claim 1, wherein said fire protection device (1) comprises a control unit (10) configured to control a movement of said movable extinguishing unit (100) based on said video data signal received from said at least one high-resolution detection unit (2, 3), wherein said control unit is configured to identify a fire event in said video data signal based on machine learning and/or to determine position coordinates from said video data signal, to determine said location in which said fire event is identified.

5. The fire protection device according to claim 1, wherein said movable extinguishing unit (100) is at least movable between a standby position, in which said extinguishing unit (100) is in a stowed state, and not able to fight a fire, and an operating position, in which said movable extinguishing device (100) is able to fight a fire, wherein said movable extinguishing unit (100) is supported at least partially translatory and/or at least partially rotatory movable along a path (P) by means of a support arrangement (200) wherein in addition or alternatively said movable extinguishing unit (100) is rotatably held by means of a pivot bearing arrangement comprising two pivot bearings supporting said movable extinguishing unit (100) rotatable about two rotational axes (A, B) that are oriented at an angle with respect to each other, wherein one of said two pivot bearings is configured such that a main extension direction of its first rotational axis (A) is parallel to a main extension direction of said path (P).

6. The fire protection device according to claim 1, wherein at least one high-resolution detection unit (2, 3) is provided on said movable extinguishing unit (100) so as to be integrally movable with the same, wherein said movable extinguishing unit (100) is configured so as to orient said high-resolution detection unit (3) towards at least a predetermined region of said space to be monitored, and in addition or alternatively such that it is oriented perpendicular with respect to a wall or ceiling surface on which said fire protection device is mounted and in addition or alternatively such that a main orientation direction of said high-resolution detection unit (100) is parallel to said first rotational axis (A) and/or parallel to said main extension direction of said path (P).

7. The fire protection device according to claim 1, wherein said movable extinguishing unit (100) comprises a housing with a cover portion, which is configured such that in said stowed state of said movable extinguishing unit (100), said cover portion substantially seamlessly integrates in a surrounding surface structure, wherein said high-resolution detection unit (3) is provided in or on said cover portion, and/or wherein at least one high-resolution detection unit (2, 3) is provided remote and independent from said movable extinguishing unit (100) so as to remain independent of a movement of said movable extinguishing unit (100), wherein in addition or alternatively at least a portion of said cover portion comprises an indicating portion configured to signalize a detected fire event and/or activity of said movable extinguishing unit (100), wherein said indicating portion is configured to provide a visual signal and comprises a translucent section allowing light of an interior signal light to pass therethrough, wherein said translucent section may comprise diffuse characteristics and is made from a plastics material.

8. The fire protection device (1) according to claim 1, wherein said movable extinguishing unit (100) comprises an extinguishing nozzle (140) for applying an extinguishing agent, wherein an output opening of said extinguishing nozzle (140) comprises a diameter equal to or smaller than 10 mm, wherein said extinguishing nozzle (140) is a nozzle normally used in 3D-printers for printing.

9. The fire protection device according to claim 1, wherein said movable extinguishing unit (100) comprises a thermal radiation detection device (150), wherein said thermal radiation detection device (150) is at least used to verify said fire event detected by said high-resolution detection unit (2, 3), wherein said extinguishing nozzle (140) and said thermal radiation detection device (150) are oriented in parallel.

10. The fire protection device (1) according to claim 1, further comprising a distance sensor (110) for determining a distance between the detected fire event and the movable extinguishing unit (100), wherein the distance sensor (110) is arranged on the movable extinguishing unit (100) with an orientation that is parallel to the orientation of the extinguishing nozzle (140) and/or parallel to an orientation of a thermal radiation detection device (150).

11. The fire protection device (1) according to claim 1, wherein said fire protection device comprises a pump device (160) connected to an extinguishing agent reservoir (161) and configured to supply extinguishing agent from said reservoir (161) to said at least one movable extinguishing unit (100), wherein said pump device (160) comprises a pump having a flow rate of 5 liters per minute or less and/or an operating pressure in a range from 10 bar to 30 bar, wherein in addition or alternatively said extinguishing agent reservoir (161) comprises a volume equal to or smaller than 5 liters and/or said extinguishing agent reservoir (161) is configured as a replaceable cartridge and/or is configured refillable, by comprising a refill valve (162).

12. The fire protection device (1) according to claim 1, wherein said fire protection device (1) comprises a housing (170) which is configured to be installed in or on a wall and/or in or on a ceiling and/or in or on a furniture, wherein said housing is configured to fully accommodate said movable extinguishing unit (100), said reservoir and/or said control unit (10) in said housing (170) when the same is in said standby position, and wherein in addition or alternatively said housing (170) comprises an opening through which said movable extinguishing unit (100) is at least partially passed in said operating position, wherein said housing (170) comprises a compact size equal to or smaller than 1000×1000×1000 mm, wherein in addition or alternatively said housing (170) is configured couplable to wall or ceiling by means of an engaging mount, wherein said housing (170) is openable and closeable for granting access to an interior of the same, and comprises a flap or door arrangement.
